(19) United States
(12) Patent Application Publication
(10) Pub. No.: US 2004/0059699 A1
(43) Pub. Date: Mar. 25, 2004

(54) Single entry point access to stored documentation

(76) Inventors: Dennis A. Evans, Mill Valley, CA (US); Stuart J. McIntyre, Brentwood, CA (US)

Correspondence Address: WAGNER, MURABITO & HAO LLP, Third Floor, Two North Market Street, San Jose, CA, 95113, US

(21) Appl. No.: 10/247,932

(22) Filed: Sep. 19, 2002

(51) Int. Cl. G06F 7/00; G06F 17/30

(52) U.S. Cl. 707/1

(57) ABSTRACT

A method for providing a single entry point for accessing installed documentation. The method comprises including an indicator with each document of a plurality of documents. Additionally, the plurality of documents are installed within a memory of a computing device. Furthermore, a determination is made as to which documents have been installed within the memory by using the indicator of each document. The single entry point is generated for accessing the plurality of documents within the memory of the computing device.

### TECHNICAL FIELD

The present invention generally relates to the field of media. More particularly, the present invention relates to the field of accessing media.

### BACKGROUND ART

Modern research and technology have provided society with a wide variety of electronic devices. It should be appreciated that some modern electronic devices also provide entertainment to their users. For instance, some of the electronic devices which fall into this category include: portable and fixed radio receivers which provide their users music along with a wide array of different audio programming, video game consoles which challenge their users with varying situations within different virtual realities, portable and fixed compact disc (CD) players which provide music to their users, and portable and fixed televisions which provide a wide variety of visual and audio programming to their users.

Additionally, it is appreciated that some of these modern electronic devices are very powerful and useful to their users. For example, some of the electronic devices which fall into this category include: satellites which orbit around the earth relaying a multitude of communication signals, global positioning system (GPS) devices capable of determining the specific locations of their users on the earth, cellular phones which enable their users to wirelessly communicate with other people, computers which occupy large office space down to computers which are held in one's hand, just to name a few.

Computers have become integral tools used in a wide variety of different applications, such as in finance and commercial transactions, computer-aided design and manufacturing, health care, telecommunication, education, etc. Computers are finding new applications as a result of advances in hardware technology and rapid development in software technology. It should be appreciated that documentation collections can be stored on computer systems thereby enable their users to access information corresponding to a wide variety of informational topics. As these documentation collections become larger and larger, it becomes more difficult to utilize them without having some type of system that provides more manageable access. Currently, there are software management systems that may be installed on a computer system that are designed to operate with documentation collections thereby enabling the computer user to find and view desired information.

However, there are disadvantages associated with the conventional documentation collection management systems. For example, one disadvantage is that the conventional documentation collection management systems are usually unable to find documentation unless it is installed in a particular directory and properly registered with the database. If one or more documentation collections are not installed within that particular directory or registered properly, the typical documentation collection management system do not know that it is installed on the computer and, as such, are unable to provide its users access to it.

Accordingly, a need exists for a way to manage documentation collections such that they are accessible no matter which directories they are stored within on the computer.

### SUMMARY OF THE INVENTION

A method for providing a single entry point for accessing installed documentation. The method comprises including an indicator with each document of a plurality of documents. Additionally, the plurality of documents are installed within a memory of a computing device. Furthermore, a determination is made as to which documents have been installed within the memory by using the indicator of each document. The single entry point is generated for accessing the plurality of documents within the memory of the computing device.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of an embodiment of an exemplary computer system that may be used in accordance with the present invention.

FIG. 2 is a flowchart of steps performed in accordance with an embodiment of the present invention for automatically providing a single dynamic entry point for accessing documentation installed on a single computing device.

FIG. 3 is an exemplary screen shot of a browser displaying an exemplary single entry point web page for associated documents and/or books in accordance with an embodiment of the present invention.

FIG. 4 illustrates a resultant exemplary screen shot of a browser displaying a table of contents web page in accordance with an embodiment of the present invention.

FIG. 5 is a flowchart of steps performed in accordance with an embodiment of the present invention for automatically providing a single entry point for accessing documentation installed on a single computing device.

### DETAILED DESCRIPTION OF THE INVENTION

Reference will now be made in detail to embodiments of the invention, examples of which are illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

### NOTATION AND NOMENCLATURE

Some portions of the detailed descriptions which follow are presented in terms of procedures, logic blocks, processing, and other symbolic representations of operations on data bits within a computing system or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps may involve physical manipulations of physical quantities. Usually, though not necessarily, these physical manipulations take the form of electrical or magnetic signals capable of being stored, transferred, combined, compared, and otherwise manipulated in a computing system or similar electronic computing device. For reasons of convenience, and with reference to common usage, these signals are referred to as bits, values, elements, symbols, characters, terms, numbers, or the like with reference to the present invention.

Bear in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “providing” or “determining” or “activating” or “controlling” or “transmitting” or “receiving” or “recognizing” or “generating” or “utilizing” or “storing” or the like, refer to the action and processes of a computing system, or similar electronic computing device, that manipulates and transforms data. The data is represented as physical (electronic) quantities within the computing system's registers and memories and is transformed into other data similarly represented as physical quantities within the computing system's memories or registers or other such information storage, transmission, or display devices.

### EXEMPLARY HARDWARE IN ACCORDANCE WITH THE PRESENT INVENTION

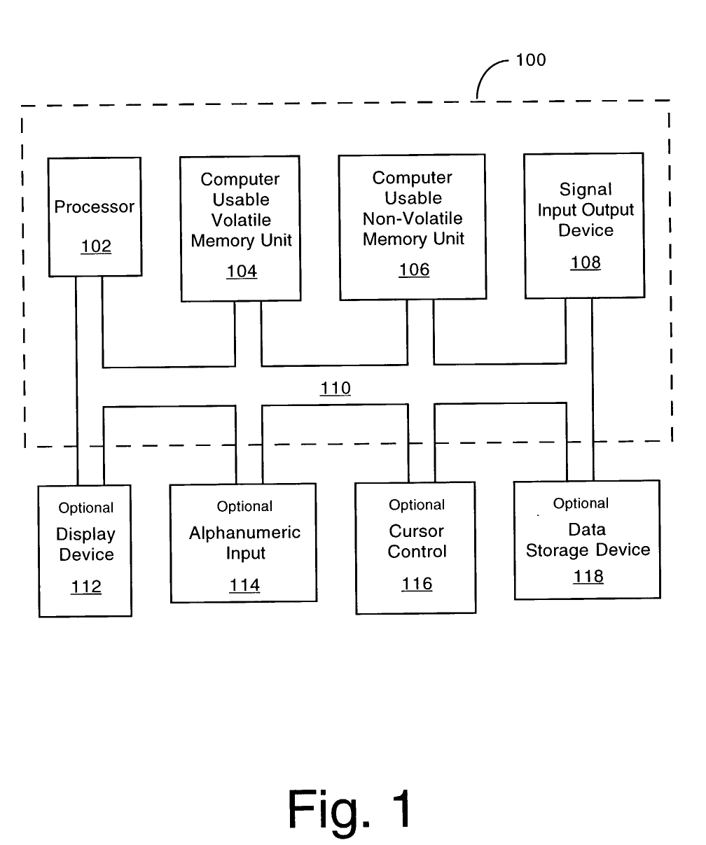

FIG. 1 is a block diagram of an embodiment of an exemplary computer system 100 that may be used in accordance with the present invention. It is understood that system 100 is not strictly limited to be a computer system. As such, system 100 of the present embodiment is well suited to be any type of computing device (e.g., server computer, desktop computer, workstation computer, laptop computer, portable computing device, etc.). Within the discussions of the present invention, certain processes and steps are discussed that are realized, in one embodiment, as a series of instructions (e.g., software program) that reside within computer readable memory units of computer system 100 and executed by a processor(s) of system 100. When executed, the instructions cause computer 100 to perform specific actions and exhibit specific behavior which is described in detail herein.

Computer system 100 of FIG. 1 comprises an address/data bus 110 for communicating information, one or more central processors 102 coupled with bus 110 for processing information and instructions. Central processor unit(s) 102 may be a microprocessor or any other type of processor. The computer 100 also includes data storage features such as a computer usable volatile memory unit 104, e.g., random access memory (RAM), static RAM, dynamic RAM, etc., coupled with bus 110 for storing information and instructions for central processor(s) 102, a computer usable non-volatile memory unit 106, e.g., read only memory (ROM), programmable ROM, flash memory, erasable programmable read only memory (EPROM), electrically erasable programmable read only memory (EEPROM), etc., coupled with bus 110 for storing static information and instructions for processor(s) 102.

System 100 also includes one or more signal generating and receiving devices 108 coupled with bus 110 for enabling system 100 to interface with other electronic devices. The communication interface(s) 108 of the present embodiment may include wired and/or wireless communication technology. For example, in one embodiment of the present invention, the communication interface 108 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In another embodiment a digital subscriber line (DSL) connection may be employed. In such a case the communication interface(s) 108 may include a DSL modem.

Optionally, computer system 100 can include an alphanumeric input device 114 including alphanumeric and function keys coupled to the bus 110 for communicating information and command selections to the central processor(s) 102. The computer 100 can also include an optional cursor control or cursor directing device 116 coupled to the bus 110 for communicating user input information and command selections to the central processor(s) 102. The cursor directing device 116 can be implemented using a number of well known devices such as a mouse, a track ball, a track pad, an optical tracking device, a touch screen, etc. Alternatively, it is appreciated that a cursor can be directed and/or activated via input from the alphanumeric input device 114 using special keys and key sequence commands. The present embodiment is also well suited to directing a cursor by other means such as, for example, voice commands.

The system 100 of FIG. 1 can also include a computer usable mass data storage device 118 such as a magnetic or optical disk and disk drive (e.g., hard drive or floppy diskette) coupled with bus 110 for storing information and instructions. An optional display device 112 is coupled to bus 110 of system 100 for displaying video and/or graphics. It should be appreciated that optional display device 112 may be a cathode ray tube (CRT), flat panel liquid crystal display (LCD), field emission display (FED), plasma display or any other display device suitable for displaying video and/or graphic images and alphanumeric characters recognizable to a user.

### EXEMPLARY OPERATIONS IN ACCORDANCE WITH THE PRESENT INVENTION

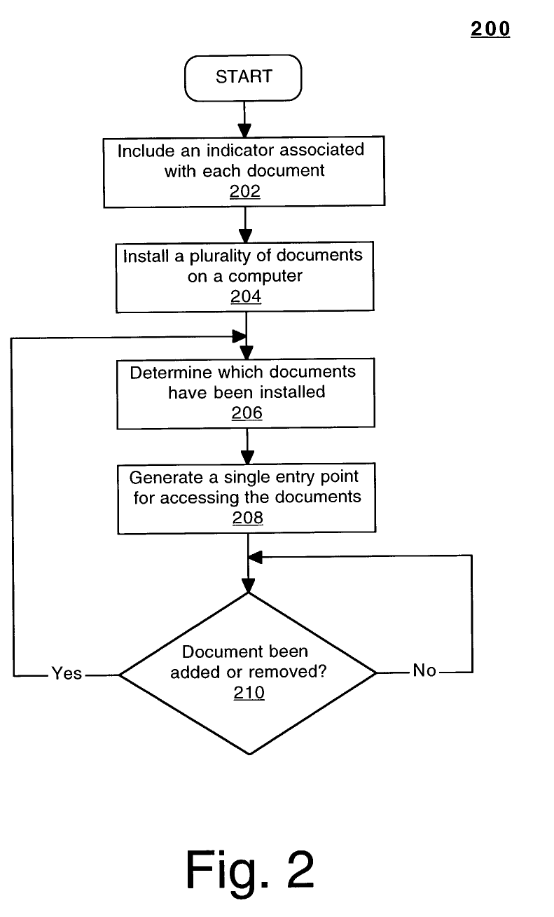

FIG. 2 is a flowchart 200 of steps performed in accordance with an embodiment of the present invention for automatically providing a single dynamic entry point for accessing documentation installed on a single computing device (e.g., 100). Flowchart 200 includes processes of the present invention which, in one embodiment, are carried out by a processor(s) and electrical components under the control of computer readable and computer executable instructions. The computer readable and computer executable instructions may reside, for example, in data storage features such as computer usable volatile memory 104, computer usable non-volatile memory 106 and/or computer usable mass data storage device 118. However, the computer readable and computer executable instructions may reside in any type of computer readable medium. Although specific steps are disclosed in flowchart 200, such steps are exemplary. That is, the present embodiment is well suited to performing various other steps or variations of the steps recited in FIG. 2. Within the present embodiment, it should be appreciated that the steps of flowchart 200 may be performed by software, by hardware or by any combination of software and hardware.

The present embodiment provides a method for automatically providing a single dynamic entry point for accessing documentation installed on a single computing device. For example, an indicator or marker is included with each document (or book) that is associated with or part of a group of one or more other documents (or books). Subsequently, one or more of the associated documents and/or books are installed on a memory of the single computer system. A determination is made as to which of the associated documents or books have been installed on the memory of the computer system. The determination may include utilizing the indicator or marker associated with each document and/or book of the group. The information gathered during the determination may then be utilized to generate a single entry point for enabling a computer user to access the associated documents and/or books installed on the computer system. If one or more of the associated documents and/or books is removed from or added to the computer memory, this may be automatically monitored in order to dynamically update the single entry point with the current associated documents and/or books installed on the computer system.

At step 202 of FIG. 2, the present embodiment includes (or affiliates) an indicator or marker with each document (or book) that is associated with one or more documents (or books). It is appreciated that the plurality of documents or books of step 202 may constitute one or more documentation collections. For example, a documentation collection may include many electronic books that are associated with an operating system (e.g., Solaris™ developed by Sun® Microsystems, Microsoft® Windows® XP, and the like) of a computer system. Additionally, the documentation collection may include a library of electronic books associated with a particular author, subject, topic and the like. The documents and/or books of step 202 are well suited to be implemented in a wide variety of formats. For example, the document format may include, but is not limited to, a Hypertext Markup Language (HTML) document, a Portable Document Format (PDF) document, an eXtensible Markup Language (XML) document, a Microsoft Word document, a WordPerfect document, a SimpleText document, and/or any other type of document format.

It is noted that the indicator or marker of step 202 that is associated with each document or book may be implemented in a wide variety of ways. For example, the indicator may be any type of flag, marker and/or label that indicates that the document or book is some how associated with other documents and/or books. The indicator or marker of each document, book or group of documents of books indicates an association of the documents by subject, category, topic, author and the like.

In step 204, the plurality of documents and/or books are installed or stored on a memory of the computer (e.g., 100). It is appreciated at step 204 that the memory of the computer may include, but is not limited to, computer usable volatile memory (e.g., 104), computer usable non-volatile memory (e.g., 106) and/or computer usable mass data storage (e.g., 118). The documents and/or books that are installed on the memory may be stored anywhere with the computer system. For example, the documents and/or books may be stored on the hard disk drive of the computer. Additionally, the documents and/or books may be stored within different directories of the hard disk drive.

At step 206 of FIG. 2, the present embodiment determines which corresponding documents and/or books have been installed or stored on the memory of the computer by utilizing the indicator associated with each document or book. For example, the present embodiment may search at step 206 the memory of the computer looking for documents and/or books having a particular category label (e.g., sun_docs, Steinbeck, etc.). In this manner, the present embodiment at step 206 is able to locate and identify any associated documents and/or books that have been installed on the memory of the computer.

In step 208, a single entry point is generated thereby enabling a user of the computer system to easily access the grouped or associated documents and/or books stored by the memory of the computer. It is understood that the single entry point generated at step 208 may be implemented in diverse ways in accordance with the present embodiment. For example, the single entry point may be implemented as a Hypertext Markup Language (HTML) file that includes links to the grouped documents and/or books. The HTML file may be located at a fixed position within the computer so that a web browser software application resident to the computer may know where to access it when initiated by a user.

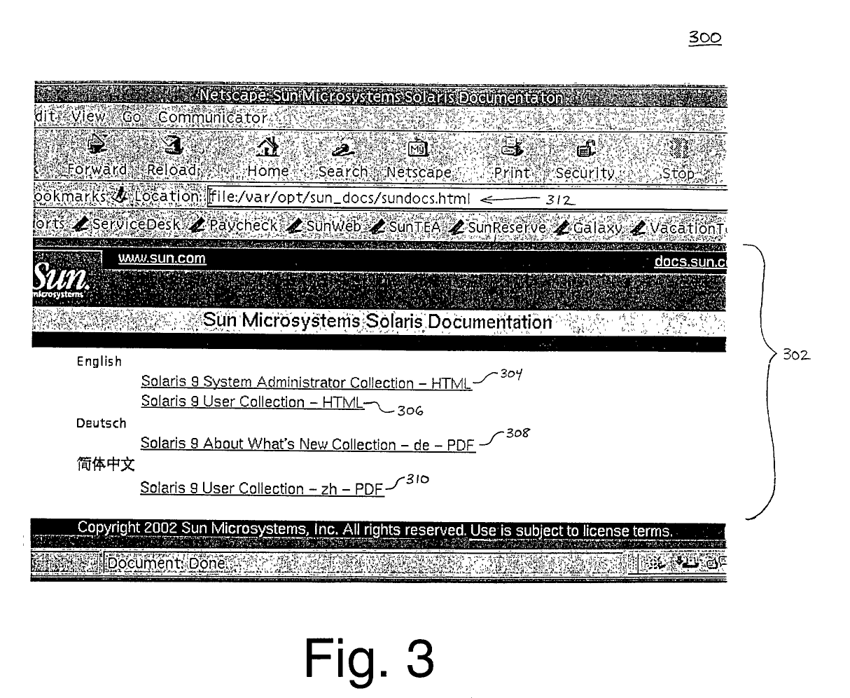

FIG. 3 is an exemplary screen shot 300 of a browser displaying an exemplary single entry point web page 302 for associated documents and/or books in accordance with an embodiment of the present invention. It is noted that the single entry point 302 displays navigation links 304, 306, 308 and 310 to documents and/or books associated with the Sun Microsystems Solaris Documentation. It is appreciated that Solaris is an operating system developed by Sun Microsystems. The single entry point navigation web page 302 displays via descriptive links 304-310 the different documents and/or books associated with the Solaris 9 operating system currently installed on the memory of the computer system.

For example, link 304 is a link to the “Solaris 9 System Administrator Collection” of books which happen to be in the HTML format while link 306 is a link to the “Solaris 9 User Collection” of books also in HTML format. Additionally, link 308 is a link to the “Solaris 9 About What's New Collection” of books written in the German language that is in the Portable Document Format (PDF) while link 310 is a link to the “Solaris 9 User Collection” of books written in Chinese also in PDF. The line 312 indicates the location of the file within the memory of the computer for the single entry point web page 302. It is appreciated that the single entry point location at line 312 may be stored by the browser as a “bookmark” or a “favorite” thereby enable easy access for a browser user to the single entry point navigation web page 302.

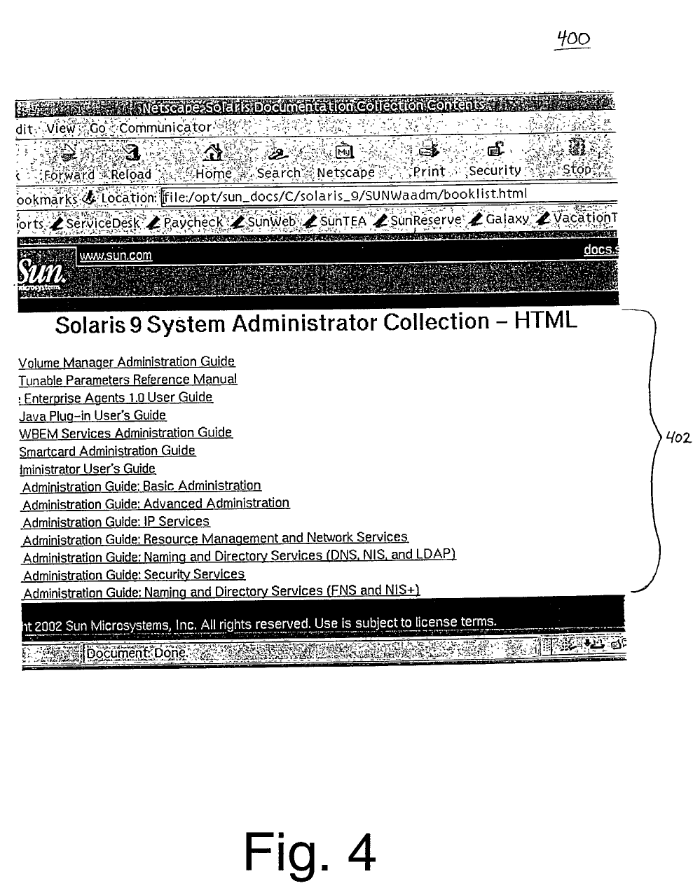

When a browser user selects one of the links 304-310, the browser then displays the documents and/or books associated with the selected link. For example, if the browser user selects link 304, FIG. 4 illustrates a resultant exemplary screen shot 400 of a browser displaying a table of contents web page 402 of book links associated with the “Solaris 9 System Administrator Collection” in accordance with an embodiment of the present invention. It is appreciated that the links of web page 402 may each be selected by the browser user in order to view its corresponding documentation. In this manner, the browser user is able to access documentation. It is noted that any collection of documentation may be listed by table of contents web page 402 in accordance with the present embodiment.

At step 210 of FIG. 2, a determination is made as to whether a document and/or book has been added to or removed from the memory of the computer system (e.g., 100). If a document and/or book has not been added to or removed from the memory of the computer system at step 210, the present embodiment proceeds to the beginning of step 210. However, if a document and/or book has been added to or removed from the memory of the computer system in step 210, the present embodiment proceeds to step 206. In this manner, the identity and location of the document and/or book that was removed or added to the memory may be determined at step 206. Furthermore, an updated single entry point may be generated at step 208 to enable user access to the associated documentation currently installed on the memory of the computer system. In this manner, flowchart 200 is able to automatically provide a single dynamic entry point for accessing documentation collections installed on the single computer system.

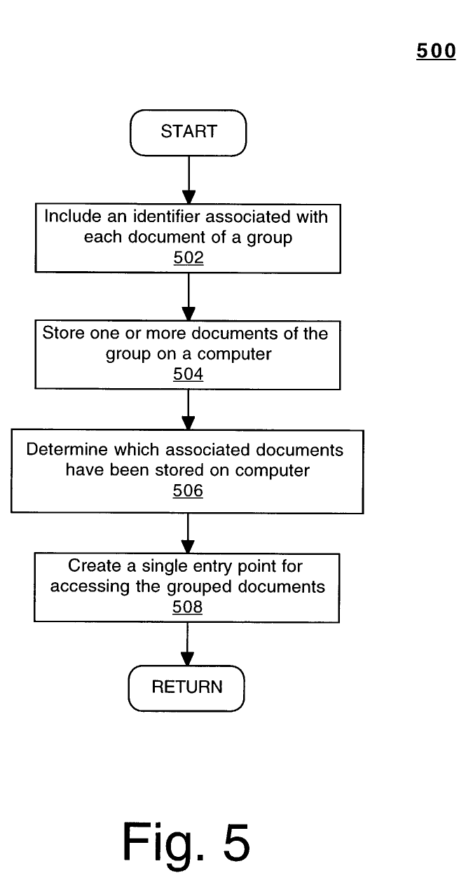

FIG. 5 is a flowchart 500 of steps performed in accordance with an embodiment of the present invention for automatically providing a single entry point for accessing documentation installed on a single computing device (e.g., 100). Flowchart 500 includes processes of the present invention which, in one embodiment, are carried out by a processor(s) and electrical components under the control of computer readable and computer executable instructions. The computer readable and computer executable instructions may reside, for example, in data storage features such as computer usable volatile memory 104, computer usable non-volatile memory 106 and/or computer usable mass data storage device 118. However, the computer readable and computer executable instructions may reside in any type of computer readable medium. Although specific steps are disclosed in flowchart 500, such steps are exemplary. That is, the present embodiment is well suited to performing various other steps or variations of the steps recited in FIG. 5. Within the present embodiment, it should be appreciated that the steps of flowchart 500 may be performed by software, by hardware or by any combination of software and hardware.

The present embodiment provides a method for automatically providing a single entry point for accessing documentation installed on a single computing device. For example, an identifier is included with each document, book and/or documentation collection that is associated with other documents, books and/or documentation collections. One or more of the associated documents, books and/or documentation collections are stored on a memory of the single computer system. Subsequently, a determination is made as to which of the associated documents books and/or documentation collections have been stored on the memory of the computer system. The determination may include utilizing the identifier associated with each document, book and/or documentation collection of the group. Information gathered during the determination may then be utilized to create a single entry point for enabling a computer user to access the associated document, book and/or documentation collection installed on the computer system.

In step 502 of FIG. 5, an identifier is included (or affiliated) with each document, book and/or documentation collection associated with a particular group of documents, books and/or documentation collections. It is understood that the group of documents, books and/or documentation collections may incorporate one or more documents, books and/or documentation collections. For example, a documentation collection may include many electronic books that are associated with a computer operating system (e.g., Microsoft Windows XP, Solaris by Sun Microsystems, and the like). It is appreciated that the documentation collection may include a library of electronic books associated with each other based on a particular subject, category, topic, author and the like. The documentation collection may be implemented in any document format. For example, the document format may include, but is not limited to, a HTML document, a PDF document, a XML document, a Microsoft Word document, a WordPerfect document, a SimpleText document, and/or any other type of document format.

The identifier of step 502 that is associated with each document, book and/or documentation collection may be implemented in diverse ways. For example, the identifier may be a label, a name, a flag or anything else that identifies that the document, book and/or documentation collection is associated with one or more documents, books and/or documentation collections. The association of the documents, books and/or documentation collections may be based on a wide variety of things. For example, the association may be based on a category, subject, topic, author, technology, machinery, science, product line and the like.

At step 504 of FIG. 5, one or more documents, books and/or documentation collections associated with a group are stored on a memory of the computer system (e.g., 100). It is understood that the documents, books and/or documentation collections that are stored on the memory of the computer system may be stored anywhere within the memory. For example, the documents, books and/or documentation collections may be stored within one or more different directories of the memory of the computer. The memory of step 504 may include, but is not limited to, computer usable volatile memory (e.g., 104), computer usable non-volatile memory (e.g., 106) and/or computer usable mass data storage (e.g., 118).

In step 506, a determination is made as to what associated documents, books and/or documentation collections are stored on the memory of the computer system. The determination of step 506 may be implemented in a wide variety of ways in accordance with the present embodiment. For example, the determination may include utilizing the identifiers included with each documents, books and/or documentation collections in order to delineate the grouping of documents, books and/or documentation collections. In this manner, the determination at step 506 is able to identify and locate any associated documents, books and/or documentation collections that have been installed on the memory of the computer.

At step 508 of FIG. 5, a single entry point is created for capacitating a user of the computer system to access the grouped or associated documents, books and/or documentation collections stored by the memory of the computer. The single entry point created at step 508 may be implemented in a wide variety of ways. For example, the single entry point for accessing the associated documentation may be implemented in any manner similar to that described herein. Once step 508 is completed, the present embodiment exits flowchart 500.

Accordingly, the present invention provides a way to manage documentation collections such that they are accessible no matter which directories they are stored within on the computer.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for providing a single entry point for accessing installed documentation, said method comprising:
including an indicator with each document of a plurality of documents;
installing said plurality of documents within a memory of a computing device;
determining which documents have been installed within said memory by using said indicator of each document; and
generating said single entry point for accessing said plurality of documents within said memory of said computing device.

2. The method as described in claim 1 wherein said single entry point comprises a file.

3. The method as described in claim 2 wherein said file is a Hypertext Markup Language (HTML) file.

4. The method as described in claim 3 wherein said HTML file is accessible via a browser.

5. The method as described in claim 1 wherein said indicator is a specific category of document.

6. The method as described in claim 1 wherein said plurality of documents comprises a Hypertext Markup Language (HTML) document, a Portable Document Format (PDF) document, an extensible Markup Language (XML) document, a Microsoft Word document, a WordPerfect document or a SimpleText document.

7. The method as described in claim 1 wherein said installing said plurality of documents within said memory includes installing documents of said plurality of documents within different directories of said memory.

8. A system for providing a single entry point for accessing installed documentation, said system comprising:
means for associating an indicator with each document of a plurality of documents;
means for installing said plurality of documents with a memory of a computing system;
means for ascertaining which documents have been installed within said memory by using said indicator of each document; and
means for creating said single entry point for accessing said plurality of documents within said memory of said computing device.

9. The system as described in claim 8 wherein said single entry point comprises a file.

10. The system as described in claim 9 wherein said file is a Hypertext Markup Language (HTML) file.

11. The system as described in claim 9 wherein said file is accessible via a browser.

12. The system as described in claim 8 wherein said indicator is a specific category of document.

13. The system as described in claim 8 wherein said plurality of documents comprises a Hypertext Markup Language (HTML) document, a Portable Document Format (PDF) document, an extensible Markup Language (XML) document, a Microsoft Word document, a WordPerfect document or a SimpleText document.

14. The system as described in claim 8 wherein means for installing said plurality of documents includes means for installing documents of said plurality of documents within different directories of said memory.

15. A computer readable medium having computer readable code embodied therein for causing a system to perform:
affiliating an indicator with each document of a plurality of documents;
storing said plurality of documents within a memory of a computing device;
ascertaining which documents have been installed within said memory by using said indicator of each document; and
creating a single entry point for accessing said plurality of documents within said memory of said computing device.

16. The computer readable medium as described in claim 15 wherein said single entry point comprises a file.

17. The computer readable medium as described in claim 16 wherein said file is a Hypertext Markup Language (HTML) file.

18. The computer readable medium as described in claim 16 wherein said file is accessible via a browser.

19. The computer readable medium as described in claim 15 wherein said indicator is a specific category of document.

20. The computer readable medium as described in claim 15 wherein said plurality of documents comprises a Hypertext Markup Language (HTML) document, a Portable Document Format (PDF) document, an extensible Markup Language (XML) document, a Microsoft Word document, a WordPerfect document or a SimpleText document.

21. The computer readable medium as described in claim 15 wherein said storing said plurality of documents within said memory includes storing documents of said plurality of documents within different directories of said memory.
